(19) United States
(12) Patent Application Publication
(10) Pub. No.: US 2009/0125487 A1
(43) Pub. Date: May 14, 2009

(54) CONTENT BASED IMAGE RETRIEVAL SYSTEM, COMPUTER PROGRAM PRODUCT, AND METHOD OF USE

(75) Inventors: Adam Rossi, Oakton, VA (US); Scott T. Acton, Charlottesville, VA (US)

Correspondence Address: ARENT FOX LLP, 1050 CONNECTICUT AVENUE, N.W., SUITE 400, WASHINGTON, DC, 20036, US

(73) Assignee: PlatinumSolutions, Inc., Reston, VA (US)

(21) Appl. No.: 12/271,554

(22) Filed: Nov. 14, 2008

Related U.S. Application Data
(60) Provisional application No. 60/996,374, filed on Nov. 14, 2007.
(60) Provisional application No. 60/996,707, filed on Nov. 30, 2007.

(51) Int. Cl. G06F 7/06; G06F 17/30

(52) U.S. Cl. 707/3; 707/E17.014; 707/E17.005; 707/E17.019; 707/104.1

(57) ABSTRACT

The present invention relates to a method and system for searching a target image in a data repository. A user may search a collection of images and retrieve images based upon the image content of a target or query image. The system may apply a combination of pre-processing techniques and image search techniques to provide matches for the target or query image.

### CROSS-REFERENCE TO RELATED APPLICATIONS

This application claims priority to U.S. Provisional Application No. 60/996,374, titled “Content Based Image Retrieval System, Computer Program Product, and Method of Use,” filed on Nov. 14, 2007, and U.S. Provisional Application No. 60/996,707, titled “Content Based Image Retrieval System, Computer Program Product, and Method of Use,” filed on Nov. 30, 2007, each of which is incorporated by reference herein in its entirety.

### BACKGROUND OF THE INVENTION

1. Field of the Invention

Aspects of the present invention relate to Content Based Image Retrieval (CBIR) methods, systems and image databases. Variations of the present invention include analysis of the content of an image to derive information from the image itself, to allow a user to search a collection of images, and to retrieve images and corresponding information according to a target or query image.

2. Summary of the Invention

Related art image retrieval systems typically search for images using metadata. For example, if a system searches for an image using the term “leopard,” the system would likely search the filename, caption, keyword, and perhaps JPEG EXIF (Joint Photographic Experts Group Exchange Image File) information or surrounding HyperText Markup Language (HTML) content of a database of images in order to find a match for the term “leopard.” Current systems typically do not search the actual content of an image in order to determine whether or not the image contains a leopard.

Other related art Content-Based Image Retrieval (CBIR) systems exist for use with organizing photographs or pictures of art work. These systems may be used by photographers or museums. However, these general systems require a high variety of colors and texture in order to distinguish images. These systems typically have difficulties distinguishing images with few colors, little texture, or complex shapes. Thus, these systems are not normally capable of use with such images as scars, marks, low color tattoos, such as “jailhouse tattoos,” and arbitrary glyphs. Glyphs may be any printed character that may be used to represent a letter, number, or concept in any historical or modern day language. Additionally, glyphs may include “made up” printed symbols which do not correspond to any known language system, an encoded writing system, or any other shape or symbols that are drawn or printed on a surface.

In addition, there is related art software that takes an image of a known and identified typed language and determines the letters and/or words contained in the image. Such Optical Character Recognition (OCR) readers require identification of a known language in order to identify a word or character. These systems are not capable of matching arbitrary glyphs from any number of languages or from newly made characters and codes.

Furthermore, other related art CBIR systems apply simple edge detection and attempt to locate the largest “blob” in the image. However, these systems are not capable of producing high quality shape information with images with few colors, little texture, or complex shapes. Thus, these systems are not normally capable of use with such images as scars, marks, low color tattoos, such as “jailhouse tattoos,” and arbitrary glyphs.

There remains a need in the art, therefore, for methods and systems that search the actual content of an image for image related information. There remains a further need in the art for methods and systems that are capable of providing high quality analysis of images having few colors, little texture, or complex shapes. There remains a further need in the art for methods and systems that are capable of analyzing arbitrary glyphs from a variety of languages or from arbitrary images that are not language related.

Aspects of the present invention overcome the above identified problems, as well as others, by providing systems, computer products, and methods for analyzing the content of an image, instead of human-entered metadata, such as file names, keywords, or captions. The term “content” may refer to color, texture, shapes, size, or any other information that can be derived from the image itself. Aspects of the present invention use a combination of pre-processing techniques and image search techniques to provide superior matches for such images as glyphs (printed symbols), tattoos, and scars and marks on the surface of the skin. Aspects of the present invention also provide for the analysis of images that do not fit into any of the previous categories.

Aspects of the present invention may be useful in identifying individuals as part of a complete multi-model biometrics solution, for example. Aspects of the present invention are capable of matching a target image, such as a photograph or sketch of a glyph, of graffiti, or of a subject's tattoo, scar, or mark, against a database of images. Such marks may include birthmarks, moles, freckles, liver spots, keloids, skin cancers, burn marks, bullet wounds, knife wounds, or any other visible mark or scar resulting from surgery, injury, natural skin discolorations, or other marking. In one aspect of the present invention, a ranked list of image results may be displayed to a user based on similarity to a target image.

Aspects of the present invention may be useful for identifying bodies or body parts that contain one or more tattoos. Further, aspects of the present invention may be useful for distance biometrics, where a photograph of an individual may be collected through surveillance techniques, such as video cameras or zoom photography, for example, and searched against a database. In addition, aspects of the present invention may also be useful in identifying bodies or body parts when traditional methods, such as fingerprint identification, are not possible or effective. Moreover, aspects of the present invention may be used to match writings or special symbols used by organized criminal groups or terrorist organizations, for example.

In matching tattoos, aspects of the present invention may be optimized for identifying “jailhouse tattoos.” These tattoos are typically created in dark blue, green, or black ink only, and do not contain the varied color characteristics of more mainstream tattoos. In addition, these tattoos typically have poorly framed contours, complicated backgrounds and textures and do not contain the well-formed contours of more mainstream tattoos. The present invention may also be used to identify a gang or group that is most often associated or affiliated with a specific logo and/or design.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

For a more complete understanding of the present invention, the needs satisfied thereby, and the objects, features, and advantages thereof, reference now is made to the following description taken in connection with the accompanying drawings.

FIG. 1 illustrates various features of an example computer system for use in conjunction with aspects of the present invention;

FIG. 2 illustrates an exemplary system diagram of various hardware components and other features, in accordance with aspects of the present invention;

FIG. 3 illustrates a system diagram in accordance with aspects of the present invention;

FIG. 4 illustrates an example flow diagram of functions performed in accordance with aspects of the present invention;

FIG. 5 illustrates an example table of weights in accordance with an aspect of the present invention;

FIGS. 6A and 6B illustrate example flow diagrams of pre-processing performed in accordance with aspects of the present invention;

FIG. 7 illustrates an example of searching by body location in accordance with aspects of the present invention;

FIG. 8 illustrates an example of search results in accordance with aspects of the present invention;

FIG. 9 illustrates a system diagram of an attribution system in accordance with aspects off the present invention; and

FIGS. 10A-10C illustrate a system using active contours in accordance with an aspect of the present invention.

### DETAILED DESCRIPTION

Aspects of the present invention relate to a system having a computer program of an optimized CBIR system that uses a variety of preprocessing techniques and image searching techniques to search a database of images. The preprocessing and image searching techniques may include various algorithms designed to analyze image content.

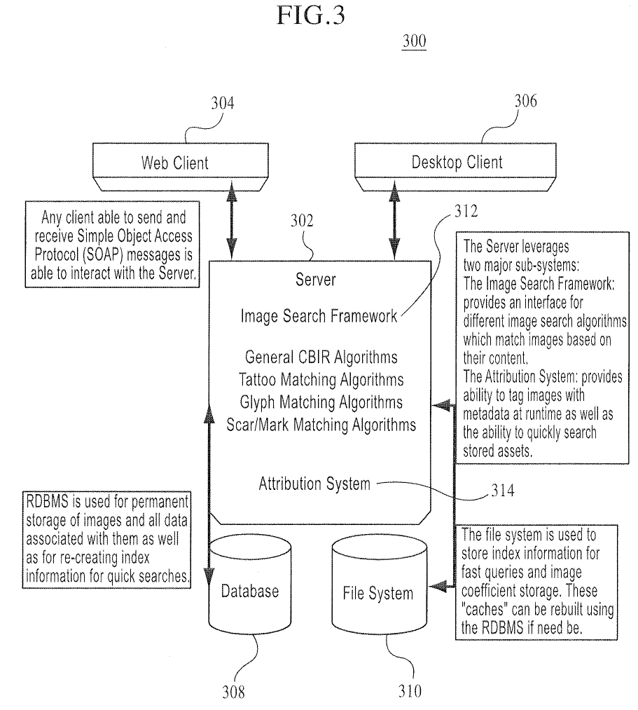

FIG. 3 illustrates a system 300 diagram in accordance with an exemplary aspect of the present invention. FIG. 3 shows a server 302 which can be accessed in a number of ways. FIG. 3 shows two exemplary options for interacting with the system 300. A user may interact with the system 300 through a web-based graphical use interface (GUI) 304 or, alternatively, via a desktop client GUI 306.

In addition, the system 300 includes a database or other data repository 308 for storage of images and data associated with the images. This repository 308 may provide for permanent storage of the images and for the storage of indexing information. The system 300 includes a file system 310 that stores index information that allows, among other things, for quicker queries and larger image coefficient storage. This file system 310 may include a cache built from information stored in the image database 308. The file system cache file is read by the server 302 at system startup and held in the Random Access Memory (RAM) of the server 302 in order to facilitate faster image matching.

The server 302 includes two sub-systems, an image search framework 312 and an attribution system 314. The attribution system 314 provides for the storage of images in the image database 308. The attribution system 314 may further provide for the ability to include optional additional information and metadata associated with the images.

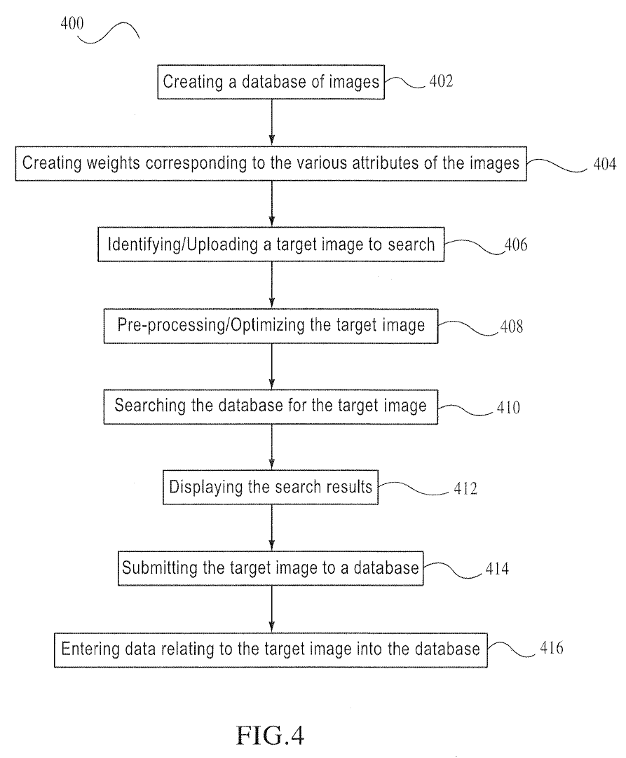

An example flow diagram 400 of functions performed in accordance with an aspect of the present invention will now be described in conjunction with FIG. 4.

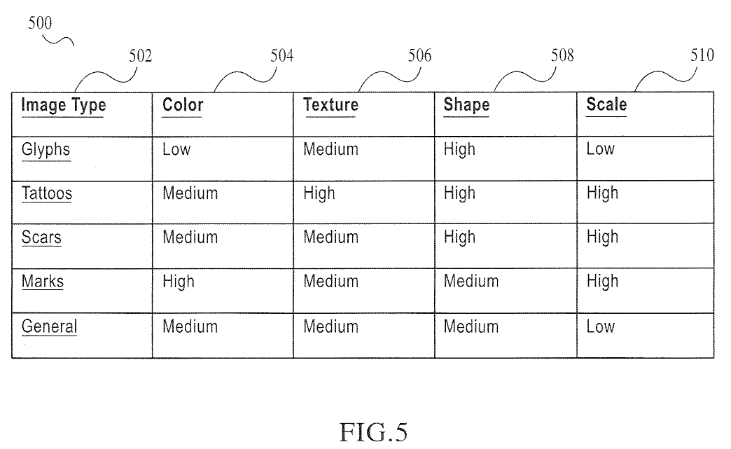

A database may be created for storing various images within the database 402. It should be appreciated that a user may add images to the database or the database may already have images stored within the database. Once the images have been stored in the database, weights may be created for various attributes of the different types of images 406 stored in the database, as illustrated in FIG. 5. These attributes may include color 504, texture 506, shape 508 and scale 510, among other image attributes. The weights may be relative (as shown in FIG. 5) where “low” is assigned a value of 1, “medium” a value of 2 and “high” a value of 3, for example. Instead, the weights may be assigned values that include any real number. The weights may be established by utilizing a ground truth database. A ground truth database may be created by a human manually classifying various images inputted into a database. Test searching algorithms may be run using the ground truth database to optimize the weights for a particular searching algorithm. Such an optimization may use a large number of initial weight assignments made by random number generation and then a combinatorial optimization technique to maximize search performance. A possible optimization technique is gradient ascent, in which a change in a given weight value is computed according to the corresponding rate of change in the search performance. Potential search performance measures include search precision, which quantifies the fraction of relevant images retrieved in the top N images retrieved.

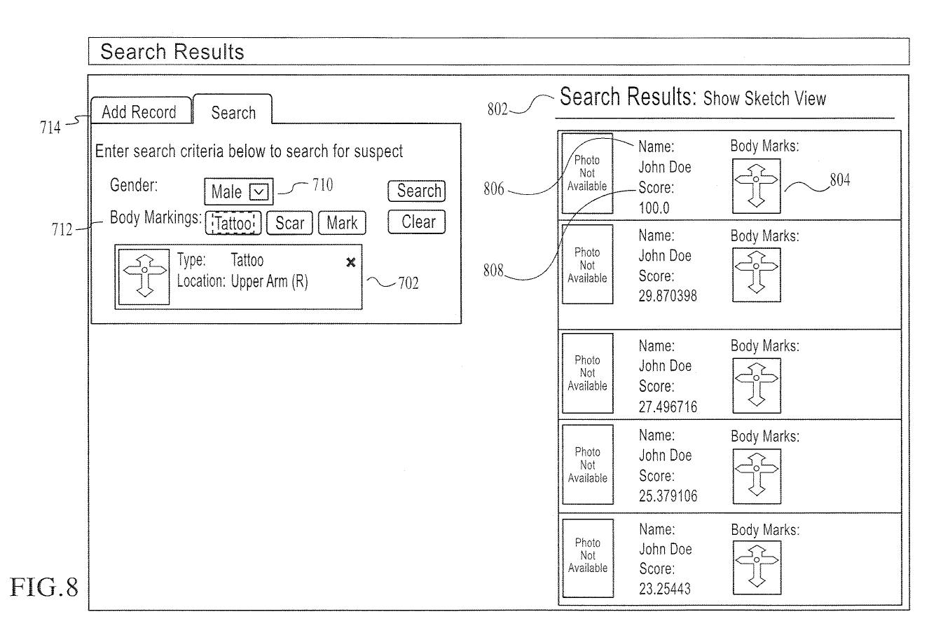

The assignment of weights is application-dependent. For example, an algorithm searching for glyphs may have different weights than an algorithm searching for tattoos, as illustrated in FIG. 8, and described in more detail below. The weights balance the overall features such as color, shape and texture. Additional weighting may be used to balance the influence of more low level features within an overall feature class. For example, within the color feature class, individual weights can be assigned and optimized for different color bands such as red, green, blue or hue, saturation, value.

Further, this weighting of the image attributes may be applied, in addition to using pre-processing techniques and searching algorithms, as discussed below. Moreover, using weights during searching may maximize the precision of retrieval of images provided in the search results. Precision of retrieval may be calculated by the percent of matching images retrieved within a number of images.

In accordance with an aspect of the present invention, once the weights are entered into the system for the attributes in connection with a particular searching algorithm, they do not change. However, it should be appreciated that if a user needs a particular set of images, a group of graffiti for example, treated in a different manner, the weights may be modified by repeating the optimization process utilizing the ground truth database, as described above. Further, it should be appreciated that the weights of the system may be re-optimized based upon updated information in the ground truth database.

Referring again to FIG. 4, a user may identify and/or upload a target image for searching and retrieval to the system 406. A user may retrieve an image for searching from a picture of an image, a digital file of an image, a digital scan of an image, a document with an embedded image, or a sketch of an image, among other sources of images. For example, the user may take a digital picture of the image, scan an image into electronic format, sketch the image on a computer, or use any other method to capture the image in an electronic format. The user may then upload the identified electronic image into the system. Moreover, the user may perform basic image editing, such as cropping, altering the color or contrast, rotating the image, and any other basic photo image editing that may be useful in preparing an image. In another aspect of the present invention, the user may identify an image previously stored in the data repository for searching.

Once a target image is identified and/or uploaded into the system, pre-processing and/or optimizing of the target image may occur 408. During pre-processing of the image, various algorithms designed to optimize the information from the target image may be applied depending on the type of content of the target image.

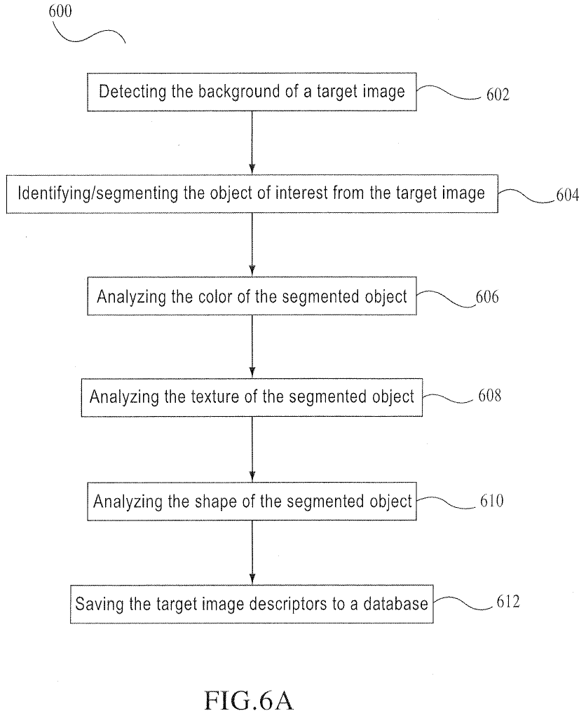

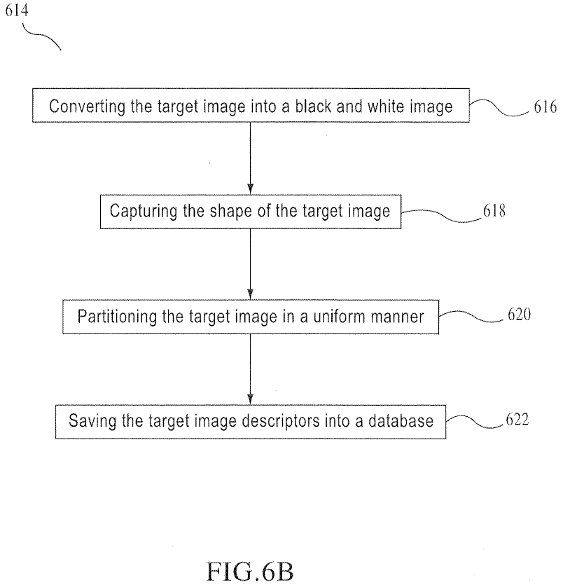

Pre-processing a tattoo target image in accordance with an aspect of the present invention, is presented in an example flow diagram 600 as illustrated in FIG. 6A. Pre-processing a tattoo target image may include detecting the background of the target image 602. This may include performing a histogram analysis based on hue, saturation, and value (HSV). Such an HSV analysis separates information on true color, which may be desired, from mere information on illumination, which may be undesired. The histogram analysis may aid the system in identifying the background and foreground of the target image. For example, identifying the background may include skin detection, a wall, a building, a document, or clothing, among other background images, in order to aid in segmenting the object of interest (i.e. tattoo, scar, mark, among other objects of interest) from the person's skin, or other background image.

Pre-processing a tattoo target image may also include identifying and segmenting an object of interest from a target image 604. This may include segmenting an object via vector field convolution to optimize active contours (also referred to interchangeably herein as “snakes”) in order to obtain accurate shape information. Such pre-processing using snakes is described in “Matching and Retrieval of Tattoo Images: Active Contour CBIR and Glocal Image Features” by Scott T. Acton and Adam Rossi, Mar. 2008, the entirety of which is incorporated herein by reference.

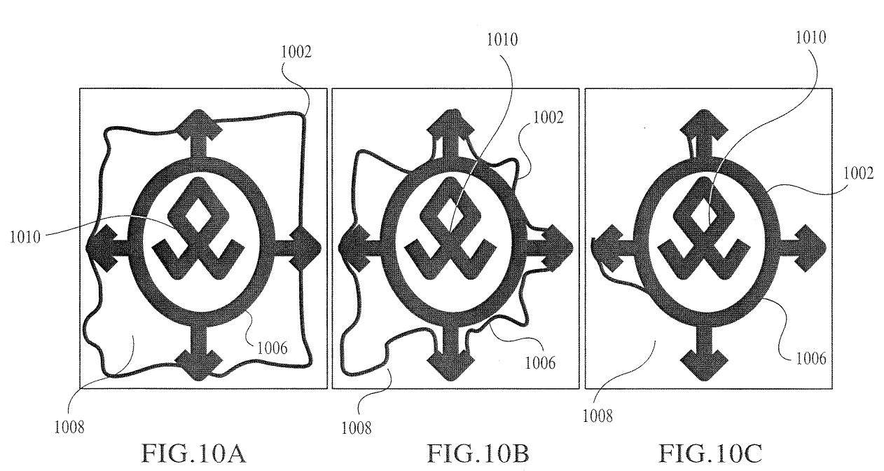

Active contours may be curves with a set of point locations (x, y) that move based on two forces. An internal force may make the contour smooth while an external force may move the curves to the target image boundaries, the border of a tattoo, scar, or mark, among other target images, by stopping the curve at peaks in edge magnitude, as illustrated in FIGS. 10A-10C. In accordance with an aspect of the present invention, the points of the curve 1002 may start at an initial position on the target image and move iteratively to the edges 1006 of the target image with the highest gradient magnitude so that the active contour 1002 comes to rest at the target image boundaries 1006. A shrinking force may be applied to move curve 1002 to the target image boundaries 1006. If the active contour 1002 is on the background of the target image 1008, the active contour 1002 may shrink faster towards the center of the target image 1010. In another aspect of the present invention when the points of the curve 1002 start at the center of the target image 1010 a force to expand the curve 1002 is applied to move the curve 1002 towards the target image boundaries 1006. It should be appreciated that the number of points on the curve may be variable. For example, the curve may have 100 points on the curve, among other numbers of points on the curve. Simultaneously, the curves attempt to maintain smoothness.

In an aspect of the present invention, vector field convolution (VFC) may be used as the external force to move the curves to the boundaries of the target image and may capture range, to increase robustness to noise, and may capture the intricacies of a shape. Further, VFC may convolve a vector field kernel with edge information by extending the field of influence to a given edge by guiding the curve to strong edges. For example, a vector field, k, may be defined as

k(x,y)=m(x,y)·n(x,y), (1)

where m(x,y) is the magnitude of the vector at (x,y) and n(x,y) is the unit vector pointing to the origin. Further, the VFC external force v(x,y)=[u(x,y),v(x,y)] may be defined by calculating the convolution of the vector field kernel k(x,y) and the edge map f(x,y), which could be normalized gradient magnitude, among others. For example,

v(x,y)=f(x,y)*k(x,y), (2)

where * denotes convolution. The edge map value f(x,y) may be larger near the image edges thus, the image edges will contribute more to the VFC than homogeneous regions of the image. Additionally, the VFC force field (u,v) may be incorporated in the following active contour partial differential equation

$$\frac{\partial x}{\partial r} = α \frac{{\partial }^{2} x}{\partial {s}^{2}} - β \frac{{\partial }^{4} x}{\partial {s}^{2}} + u ( x , y ) , \frac{\partial y}{\partial r} = α \frac{{\partial }^{2} y}{\partial {s}^{2}} - β \frac{{\partial }^{4} y}{\partial {s}^{2}} + v ( x , y ) , \qquad ( 3 )$$

for time t and contour parameter s. Here α and β may be a typical active contour tension and rigidity parameters.

Once the active contour “snakes” lay across the target image boundary, the object of interest within the target image may be extracted and/or segmented from the background of the target image. For example, if the user wanted to search a tattoo, among other images, the tattoo may be segmented from the background skin in the image and the user can search images based on the segmented tattoo image. Further, it should be appreciated that the system may have an intelligent initialization where the system performs a quick sketch on the image and moves the curves towards the boundaries of the object of interest using a quick sketch of the image.

Referring again to FIG. 6A, pre-processing an image may also include color analysis on the segmented object from a target image 606. The color analysis may include performing a histogram analysis based on hue, saturation, and value (HSV) on the segmented object. Such an HSV analysis separates information on true color, which may be desired, from mere information on illumination, which may be undesired. It should be appreciated that HSV analysis may have a variety of bins (i.e. 16 hues, 64 hues, 256 hues, etc.), and may be coarser or finer, among other variations, depending on what type of analysis is desired. Also, the HSV histogram may be performed on only the segmented object, not the background image or images surrounding the segmented object. For example, if the target image is of a tattoo on a person's skin, the histogram analysis may be performed only on the tattoo itself, and not on the person's skin. In another aspect of the present invention, the color analysis may include different color spaces (i.e. RGB (red-green-blue) and YCBR (green-blue-red), among other color spaces).

In accordance with an aspect of the present invention, pre-processing a target image may also include texture analysis on the segmented object from a target image 608. Texture may be patterns in the image that have a certain period density and a certain directionality. Examples of images with texture include, among others, images with marble, pine tree needles, brick pattern, skin with wrinkles, or concrete. Texture may be analyzed via wavelets. Haar wavelets may be used, for example, to describe texture, granularity, directionality, and position. From a larger set of texture features, a predetermined number of dominant texture components may be selected to represent the texture features of an image. For example, if about 16,000 initial texture features are obtained, the system may select about 50 or 60 dominant texture components to represent the image. In an aspect of the present invention, these dominant texture components may be used to search images with at least a certain number of texture components in common to the image. Thus, the search space may be pruned by eliminating the need to search images that are not similar to the image. In other aspects of the present invention, texture may be analyzed using a Fourier transform of the segmented object and special grey level dependency matrix (STLD), among other analysis methods.

Pre-processing a target image may also include analyzing the shape of the segmented object from the target image 610. Shape may be analyzed via Fourier Shape Descriptors (FSD), for example. This approach provides for translation, rotation and scaling and allows a shape to be matched to another shape regardless of rotation, scaling and translation. In addition, this type of description may be very compact. For example, about five of thirty-two FSD descriptors may adequately describe the shape of a target image.

The various image descriptors of the segmented object may be saved into a data repository 612. In an aspect of the present invention, the image descriptors may include color 606, texture 608, and shape 610, among other descriptors. These image descriptors may be used in searching and retrieving similar images to the segmented object.

Other pre-processing may include cropping of the target image, conversion to black and white, and skeletonizing the target image by reducing line width to a single line, among other manipulations of the target image. The pre-processing techniques may be used to provide an optimized image for computer matching depending on the type of image. For example, different pre-processing may be used for tattoos, scars, marks, and general images.

Pre-processing a glyph target image in accordance with an aspect of the present invention, is presented in an example flow diagram 614 illustrated in FIG. 6B. The pre-processing may include the use of algorithms to minimize the effect of glyph scale and rotation. The pre-processing for glyphs may include converting the target image into black and white 616, capturing the shape of the target image 618, and partitioning the target image in a uniform manner 620. For example, the target image may be partitioned in a pie shape or a gray shape, among other partitions. The system may save the various image descriptors of the glyph image, shape and partitioning among other image descriptors, into a data repository 622. These image descriptors may be used in searching and retrieving similar images to the segmented object.

In an aspect of the present invention, the system matches glyphs to freehand sketches of glyphs. For this type of image, the system leverages the shape found in the image and minimizes the effect of scale and color. Although known systems may be capable of identifying a typed character from an identified language, aspects of the present invention are capable of matching arbitrary glyphs without requiring the identification of a language. In addition, arbitrary glyphs from a newly created language, such as a new code used among prisoners or gang member may also be matched and identified. Further, association of a glyph to a predetermined alphabet may not be required.

In accordance with aspects of the present invention, different pre-processing techniques may be applied in analyzing glyphs, tattoos, scars, marks, and generalized images.

For example, in generalized image matching, scale, color, texture, and shape may be leveraged to retrieve the most visually similar images from the database.

In addition to these pre-processing techniques, the system may also use weighting, described in more detail above, to maximize the precision of the retrieval of matching images.

Among the various methods of determining the scale of an image, an aspect of the present invention includes the feature of automatically or otherwise detecting a ruler or other measurement standard in a photo or image and using this measurement image for scale information of a scar, mark, or tattoo. The scale information may automatically or otherwise be saved in association with the image of the scar, mark, or tattoo. In another aspect of the present invention, the system may be able to generalize the scale of an image. For example, if an arm, finger or torso, among other body parts, is in the image, the system can generalize that an average human body part is a certain length and diameter, among other approximations. The system may create an estimation of the scale of the tattoo, scar, or mark, among other images, based upon the approximation of the scale of the image. For example, if the image included a tattoo on an arm, the system may generalize an average male human arm may be approximately ten inches in circumference and use this approximation to estimate the scale of the tattoo is three inches across in diameter, for example. The scale information may be used to retrieve similar images of the same scale.

Referring again to FIG. 4, after the target image information has been optimized during pre-processing, the user may search a data repository for the target image or images similar to the target image 410. After performing the search, a list of search results with matching images is displayed 412. The matching images may be ranked according to degree of similarity to the target image. For example, the user may search by target image, by sketch, by metadata, by body location, or by a combination query, which combines target image, sketch, metadata, and/or body location search elements into a single query, among other searches. For example, the system may allow a user to perform a combination search by searching target image and metadata in a single search.

The system of aspects of the present invention pre-processes the image to optimize the image for searching and then searches a database for the image. After performing the search, the system displays a search result with a list of matching images. The system may rank the matching images according to degree of similarity to the target image.

By selecting an individual image within the search result list in accordance with aspects of the present invention, the user can obtain additional information regarding the individual image. Such information may include a written description of the image, other information or metadata associated with the image, a description or depiction of a location of the image on a subject's body, a magnified view of the image, among other information.

In accordance with aspects of the present invention, a user may use a sketch tool to draw an approximation of a desired image. This sketch tool may be included, for example, in a web interface to the system. After a sketch is entered using the sketch tool or other appropriate tool, the system uses the sketch to search for similar images.

A user may query by metadata by typing information regarding an image into the system, for some aspects of the present invention. The system may include a plurality of fields for the entry of information related to various aspects of an image. The system searches for text information entered regarding the image purely using text information previously entered for the images in the data base.

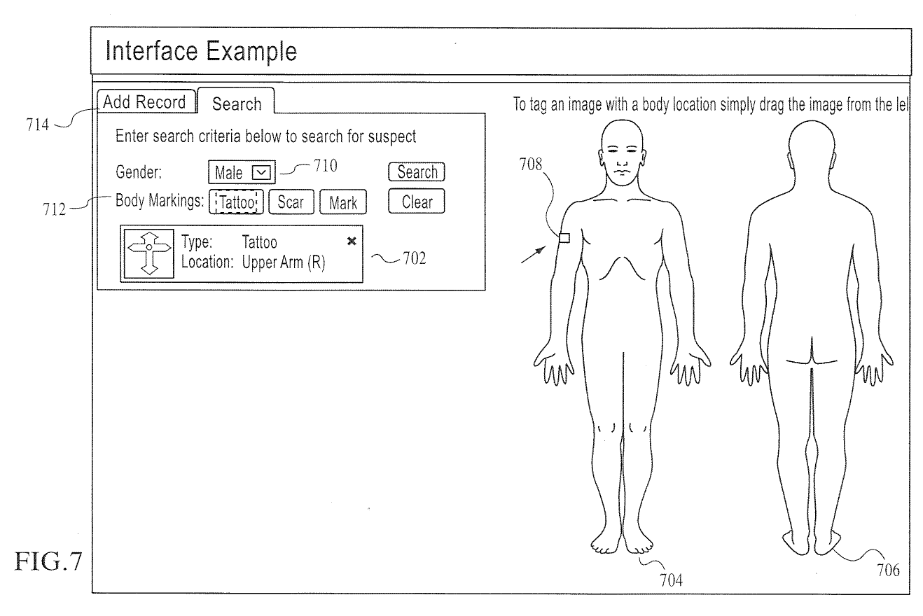

In aspects of the present invention, a user may query an image by location on a body, as illustrated in FIG. 7. The user may submit an image or sketch 714 that is associated with a location on a subject's body 702. In an aspect of the present invention, the user may input the gender of the individual in the image 710, the body marking type 712, and the location of the marking 702, among other information. In order to facilitate this association, the system may include a feature that provides a front 704 and rear 706 graphical depiction of a human body. This depiction may be similar to the graphical depiction used by a medical examiner during an autopsy. The user may designate the location of the image on the depiction of the human body 708. For example, the user may drag the image to the desired location. In an aspect of the present invention, the user may sketch the image on the body. This location and/or image information may be saved in the repository. The location information may be used to retrieve similar images located in the relevant area of the body, as illustrated in FIG. 8.

In accordance with an aspect of the present invention, a search result list 802 containing images 804 that are similar to the images located in the relevant area of the body may be displayed. Along with the name of the individual 806 and a score 808, indicating a degree of relevancy of the image displayed to the imaged searched. According to an aspect of the present invention, search result list 802 may be displayed based upon the rank of the score in descending order. However, it should be appreciated that the user may customize how the search result 802 is displayed.

In one aspect of the present invention, a plurality of numerical coefficients may be calculated that describe the optimized image in numerical form. The information from the numerical coefficients may be normalized, so that the coefficients can be compared among image types. For example, the numerical coefficients are normalized so that a glyph may be searched against tattoos, sketches, scars, marks, and other types of images. The search results provide a consolidated list from the different searching algorithms, thus providing one common ranking for the search.

In performing a search, a numerical similarity index may be used to determine the most similar images. For example, 100% similarity would mean that the images are the same, and 0% similarity would mean that the images have nothing in common.

In one aspect of the present invention, the system searches a memory cache of these numerical coefficients, rather than the images in the image database. This approach provides for quicker search results. As discussed above, these numerical coefficients include optimized information on each of the images in the image database. In FIG. 3, these numerical coefficients may be located in the File System 310.

In this aspect of the present invention, the system reads some or all of the numerical coefficients for each of the optimized images into a compressed format in the memory of the server. A search is conducted against this memory cache. Once the most similar images are identified, the system retrieves the original image and other associated information for the identified images from the image database and displays them to the user.

Referring again to FIG. 4, aspects of the present invention may also include the creation and maintenance of an image repository. Images for searching may be uploaded and stored in the image repository for use in future searches 414. Two versions of each image may be stored in the repository, the original image and an optimized version. When the original image is entered into the system, an optimized version is created using techniques similar to the pre-processing techniques for a target image. Both the original and the optimized image are stored in the database.

Further, the repository may allow for additional information entered by the user in connection with the images 416. For example, the repository may allow an image entry to include corresponding metadata describing the image type, classification, source, affiliation, among other image information. The data entry may allow for the entry of additional notes regarding the image. After entry, the image becomes available for future searches. In addition, the image may be indexed by system algorithms.

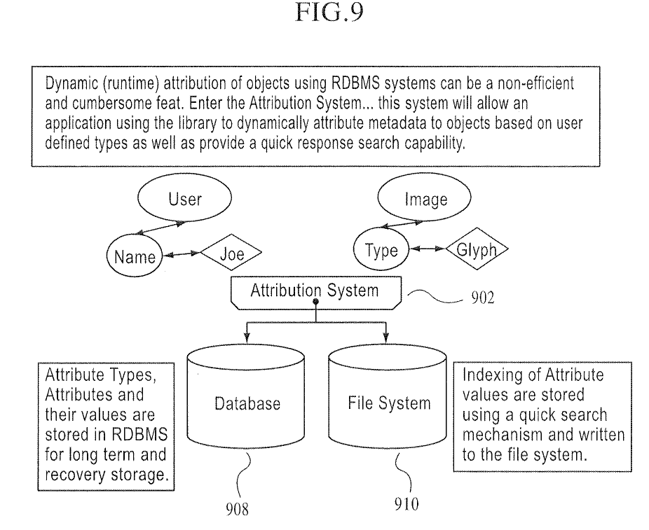

FIG. 9 illustrates an exemplary attribution system 902 according to an aspect of the present invention. The attribution system 902 shown in FIG. 9 includes a data repository 908 and a file system 910. In this aspect of the present invention, the repository 908 stores all images in the attribution system 902, their attributes, values, and associated information. The file system 910 stores an index of attribute values for each of the images in the repository 908. The file system 910 allows for a quick search mechanism to be used.

The attribution system 902 of some aspects of the present invention provides for the storage of new images and the association of information and/or metadata with images. For example, the system may allow for the association of such information as image source, image content, image description, or other data that describes or is associated with the image. In an aspect of the present invention, the attribution system 902 provides the ability to create categories of information and to associate information with classes of images or users. This information may include such things as the date a photograph was taken, a part of a body involved (in the case of an image of a scar, mark, or tattoo), gang affiliation related to an image, etc. As the desired categories of information will be different among different types of users or user communities, an aspect of the present invention allows a system administrator or other user to customize the information that will be captured or included with each image. The metadata and other information associated with an image may be searchable through a search interface.

In addition, the repository 908 may store multiple versions of an image. For example, the database 908 may store the original image and an optimized image that is obtained after.

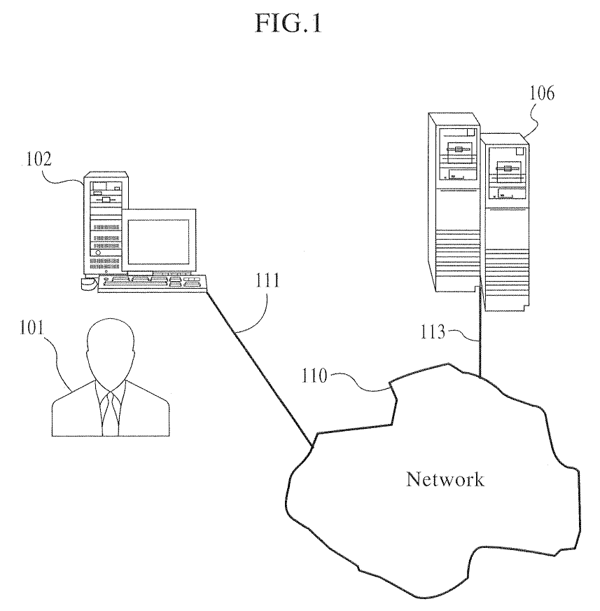

Aspects of the present invention may be implemented using hardware, software, or a combination thereof and may be implemented in one or more computer systems or other processing systems. In an aspect of the present invention, the invention is directed toward one or more computer systems capable of carrying out the functionality described herein. An example of such a computer system 100 is shown in FIG. 1.

Computer system 100 includes one or more processors, such as processor 104. The processor 104 is connected to a communication infrastructure 106 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 100 can include a display interface 102 that forwards graphics, text, and other data from the communication infrastructure 106 (or from a frame buffer not shown) for display on a display unit 130. Computer system 100 also includes a main memory 108, preferably random access memory (RAM), and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

Alternative aspects of the present invention may include secondary memory 110 and may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 180, a hard disk installed in hard disk drive 170, and signals 128. These computer program products provide software to the computer system 100. The invention is directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features of the present invention, as discussed herein. In particular, the computer programs, when executed, enable the processor 110 to perform the features of the present invention. Accordingly, such computer programs represent controllers of the computer system 100.

In an aspect of the present invention where the invention is implemented using software, the software may be stored in a computer program product and loaded into computer system 100 using removable storage drive 114, hard drive 112, or communications interface 120. The control logic (software), when executed by the processor 104, causes the processor 104 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, the invention is implemented using a combination of both hardware and software.

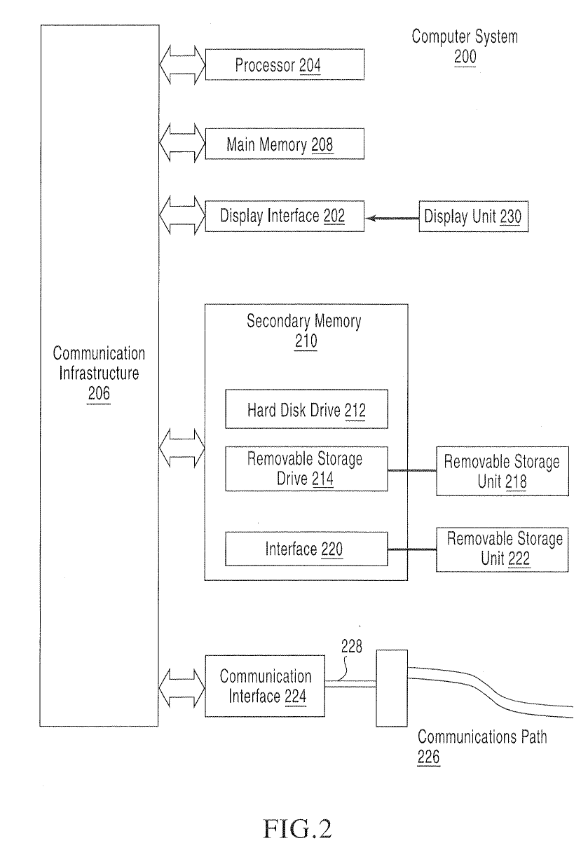

FIG. 2 shows a communication system 200 usable in accordance with the present invention. The communication system 200 includes one or more accessors 260, 262 (also referred to interchangeably herein as one or more “users”) and one or more terminals 242, 266. In one aspect of the present invention, data for use is, for example, input and/or accessed by accessors 260, 264 via terminals 242, 266, such as personal computers (PCs), minicomputers, mainframe computers, microcomputers, telephonic devices, or wireless devices, such as personal digital assistants (“PDAs”) or a hand-held wireless devices coupled to a server 243, such as a PC, minicomputer, mainframe computer, microcomputer, or other device having a processor and a repository for data and/or connection to a repository for data, via, for example, a network 244, such as the Internet or an intranet, and couplings 245, 246, 264. The couplings 245, 246, 264 include, for example, wired, wireless, or fiberoptic links. In another aspect of the present invention, the method and system of the present invention operate in a stand-alone environment, such as on a single terminal.

While the present invention has been described in connection with various aspects of the present invention, it will be understood by those skilled in the art that variations and modifications of the aspects of the present invention described above may be made without departing from the scope of the invention. Other aspects will be apparent to those skilled in the art from a consideration of the specification or from a practice of the invention disclosed herein.

What is claimed is:

1. A method for searching a target image, the method comprising:
creating a data repository of images;
identifying the target image to search;
pre-processing, via a computer, the target image, wherein an object of interest is segmented from a target image;
searching, via the computer, the object of interest for matches in the data repository; and
presenting the search results on a presentation device.

2. The method of claim 1, wherein segmenting the object of interest uses active contours.

3. The method of claim 1, wherein the search is one of search by target, search by sketch, search by body location, search by metadata, and search by a combination of searches.

4. The method of claim 1, wherein the object of interest includes one of a scar, mark, glyph, graffiti, and tattoo.

5. The method of claim 1, further comprising:
detecting a background of the target image;
analyzing a color content of the object of interest;
analyzing a texture content of the object of interest;
analyzing a shape content of the object of interest;
uploading the target image to the data repository; and
entering data associated with the target image in the data repository.

6. The method of claim 1, wherein weights are created for the images stored in the data repository.

7. A system for searching a target image, the system comprising:
a data repository;
an identifying means for identifying the target image to search;
a means for pre-processing the target image, wherein an object of interest is segmented from a target image;
a searching means for searching the object of interest for matches in the data repository; and
a presentation means for presenting the search results.

8. The system of claim 7, wherein segmenting the object of interest uses active contours.

9. The system of claim 7, wherein the search is one of search by target, search by sketch, search by body location, search by metadata, and search by a combination of searches.

10. The system of claim 7, wherein the object includes one of a scar, mark, glyph, graffiti, and tattoo.

11. The system of claim 7, further comprising:
means for detecting a background of the target image;
means for analyzing a color content of the object of interest;
means for analyzing a texture content of the object of interest;
means for analyzing a shape content of the object of interest;
means for uploading the target image to the data repository; and
means for entering data associated with the target image in the data repository.

12. The system of claim 7, wherein weights are created for the images stored in the data base.

13. A system for searching a content of an image, the method comprising:
a processor;
a user interface functioning via the processor; and
a repository accessible by the processor;
wherein a data repository of images is created;
wherein a target image is identified for searching;
wherein pre-processing of a target image segments an object of interest from a target image;
wherein searching is performed on the object of interest for matches in the data repository; and
wherein search results are presented on a presentation device.

14. The system of claim 13, wherein the processor is housed on a server.

15. The system of claim 14, wherein the server is coupled to a network.

16. The system of claim 13, wherein the coupling is selected from a group consisting of a wired connection, a wireless connection, and a fiberoptic connection.

17. The system of claim 13, wherein the repository is housed on a server.

18. The system of claim 17, wherein the server is coupled to a network.

19. A computer program product comprising a computer usable medium having control logic stored therein for causing a computer to search a content of an image, the control logic comprising:
first computer readable program code means for creating a data repository of images;
second computer readable program code means for identifying a target image to search;
third computer readable program code means for pre-processing the target image, wherein an object of interest is segmented from a target image;
fourth computer readable program code means searching the object of interest for matches in the data repository; and
fifth computer readable program code means for presenting the search results.

20. The method of claim 1, wherein the presentation device is one selected from a group consisting of a display device, a printing device, and an audio device.
